(19) United States
(12) Patent Application Publication
(10) Pub. No.: US 2008/0309849 A1
(43) Pub. Date: Dec. 18, 2008

(54) LIGHT SOURCE UNIT, BACKLIGHT ASSEMBLY INCLUDING THE SAME, LIQUID CRYSTAL DISPLAY DEVICE INCLUDING THE SAME, AND METHOD THEREOF

(75) Inventor: Dong Choul YANG, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 12/055,445

(22) Filed: Mar. 26, 2008

(30) Foreign Application Priority Data
Mar. 26, 2007 (KR) 10-2007-0029098

(51) Int. Cl. G02F 1/1335; F21V 7/04

(52) U.S. Cl. 349/65; 362/619

(57) ABSTRACT

A light source unit includes a light source, and a light guide pipe formed in a columnar shape and including a plurality of grooves, to which light emitted from the light source is incident, wherein dimensions of the grooves further from the light source are different from dimensions of the grooves closer to the light source, respectively.

This application claims priority to Korean Patent Application No. 10-2007-0029098, filed on Mar. 26, 2007, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display (“LCD”) device and, more particularly, to a light source unit, which has excellent light source efficiency and can be manufactured at low cost, a backlight assembly including the light source unit, an LCD device including the backlight assembly, and a method thereof.

2. Description of the Related Art

Liquid crystal display (“LCD”) devices, typical flat panel display devices, are widely used in various application fields because they are generally lightweight and compact and require low power consumption.

Recently, extensive research aimed at improving the structures of respective elements such as a backlight, a connector, a printed circuit board (“PCB”), which constitute the LCD device, has continued to progress in order to achieve a slim and lightweight LCD device.

The LCD device includes an LCD panel, a backlight assembly providing light to the LCD panel, and a driving circuit generating various signals required for displaying an image. The LCD device also includes a mold frame receiving the LCD panel and a bottom chassis accommodating the backlight assembly.

A light source of the LCD device is broadly classified into a cold cathode fluorescent lamp (“CCFL”) and a light emitting diode (“LED”). Although the CCFL is widely used as the light source of the LCD device, the use of LEDs is gradually increasing. In a case where the LED is used as the light source of the LCD device, it is necessary to employ a plurality of LEDs so as to convert point light sources of the LEDs into a line light source or a surface light source.

Such an LED provides advantages of compactness and high color reproduction.

### BRIEF SUMMARY OF THE INVENTION

It is determined herein that the use of light emitting diodes (“LEDs”) as a light source of a liquid crystal display (“LCD”) device causes problems in that heat generation characteristics are not good, its lifespan is reduced, and material costs are high. Moreover, since the plurality of LEDs is used as the light source of the conventional LCD device, the process of manufacturing the backlight assembly requires a very high material cost.

Thus, exemplary embodiments of the present invention provide a light source unit including a light guide pipe and a light source, which has excellent light source efficiency and can be manufactured at low cost, a backlight assembly including the light source unit, an LCD device including the backlight assembly, and a method of providing light in an LCD device.

In exemplary embodiments, a light source unit includes a light source, and a light guide pipe formed in a columnar shape, such as a cylindrical shape, and including a plurality of grooves, to which light emitted from the light source is incident, wherein dimensions of the grooves further from the light source are different from dimensions of the grooves closer to the light source, respectively.

A length of a groove positioned further from the light source may be longer than a length of a groove positioned closer to the light source. Alternatively, a depth of a groove positioned further from the light source may be deeper than a depth of a groove positioned closer to the light source. Lengths or depths of the grooves may increase, respectively, towards a center portion of the light guide pipe.

The light source may include a first light source positioned at a first end of the light guide pipe, and a second light source positioned at a second end of the light guide pipe.

The light source may include a point light source emitting the light, and the grooves may reflect the light from the point light source to form a line light source of substantially uniform brightness.

In other exemplary embodiments, there is provided a backlight assembly including a light source unit emitting light, and a light guide plate guiding the light emitted from the light source unit, wherein the light source unit may include a light guide pipe formed in a columnar shape and including a plurality of emitting patterns formed on a surface facing the light guide plate, and a light source portion connected to at least one end of the light guide pipe and emitting light to an inside of the light guide pipe.

The emitting patterns may be grooves formed to be parallel to both ends of the light guide pipe. Alternatively, the grooves may be formed to be angled to both ends of the light guide pipe.

The grooves may have a V shaped section.

A depth of a groove positioned closer to an end of the light guide pipe may be less than a depth of a groove positioned adjacent a center portion of the light guide pipe.

A length of a groove positioned closer to an end of the light guide pipe may be less than a length of a groove positioned adjacent a center portion of the light guide pipe.

The light source portion may include a housing including an insertion hole of which a first end of the insertion hole receives the light guide pipe, a light emitting diode (“LED”) package connected within a second end of the insertion hole and including an LED emitting light, and a power supply substrate formed on a lower portion of the housing and supplying power to the LED.

The light source portion may include a point light source emitting the light, and the emitting patterns may reflect the light from the point light source to form a line light source of substantially uniform brightness.

In still other exemplary embodiments, an LCD device includes an LCD panel displaying an image, a driving circuit for driving the LCD panel, a light source unit formed on a lower portion of the LCD panel and emitting light, and an optical sheet formed on the lower portion of the LCD panel, wherein the light source unit may include a light source emitting light, and a light guide pipe formed in a columnar shape and including a plurality of grooves, to which the light emitted from the light source is incident, wherein dimensions of the grooves further from the light source are different from dimensions of the grooves closer to the light source.

A length of a groove positioned further from the light source may be longer than a length of a groove positioned closer to the light source. A depth of a groove positioned further from the light source may be deeper than a depth of a groove positioned closer to the light source.

In yet other exemplary embodiments of the present invention, a liquid crystal display device includes a liquid crystal display panel displaying an image, a plurality of light source units formed on a lower portion of the liquid crystal display panel and arranged parallel to each other, and an optical sheet formed on the lower portion of the liquid crystal display panel. Each of the light source units includes the light guide pipe formed in a columnar shape and the light source portion connected to at least one end of each of the light guide pipes and emitting light to an inside of the light guide pipe. The light guide pipe include a plurality of emitting patterns formed on a surface facing the light guide plate.

A length of a groove positioned further from the light source is longer than a length of a groove positioned closer to the light source. A depth of a groove positioned further from the light source is deeper than a depth of a groove positioned closer to the light source.

### BRIEF DESCRIPTION OF THE DRAWINGS

The above and other features of the present invention will be described in reference to certain exemplary embodiments thereof with reference to the attached drawings in which:

FIG. 1 is an exploded perspective view illustrating an exemplary embodiment of a liquid crystal display (“LCD”) device in accordance with the present invention;

FIG. 2 is a cross-sectional view taken along line I-I′ of FIG. 1;

FIG. 3 is a perspective view illustrating an exemplary embodiment of a light source unit and a light guide plate of FIG. 1;

FIG. 4 is a front view illustrating an exemplary embodiment of the light source unit of FIG. 3;

FIG. 5 is an exploded perspective view illustrating an exemplary embodiment of the light source unit of FIG. 3;

FIG. 6 is a cross-sectional view taken along line II-II′ of FIG. 5;

FIG. 7A is an enlarged cross-sectional view illustrating a first exemplary embodiment taken along c-e of FIG. 4 in accordance the present invention;

FIG. 7B is an enlarged cross-sectional view illustrating a second exemplary embodiment taken along c-e of FIG. 4 in accordance with the present invention;

FIG. 7C is a cross-sectional view taken along line III-III′ of FIGS. 7A and 7B;

FIG. 8A is an enlarged cross-sectional view illustrating a third exemplary embodiment taken along c-e of FIG. 4 in accordance with the present invention;

FIG. 8B is an enlarged cross-sectional view illustrating a fourth exemplary embodiment taken along c-e of FIG. 4 in accordance with the present invention;

FIG. 8C is a cross-sectional view taken along line IV-IV′ of FIGS. 8A and 8B;

FIG. 9 is a plan view showing a state in which light emitted from an exemplary light source portion is emitted through exemplary emitting patterns of an exemplary light guide pipe;

FIG. 10 is an exploded perspective view illustrating another exemplary embodiment of an LCD device in accordance with the present invention; and

FIG. 11 is an exploded perspective view illustrating a further exemplary embodiment of an LCD device in accordance with the present invention.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “lower”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “beneath” other elements or features would then be oriented “above” the other elements or features. Thus, the exemplary term “beneath” can encompass both an orientation of above and below. The device may be otherwise oriented (rotated 90 degrees or at other orientations) the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

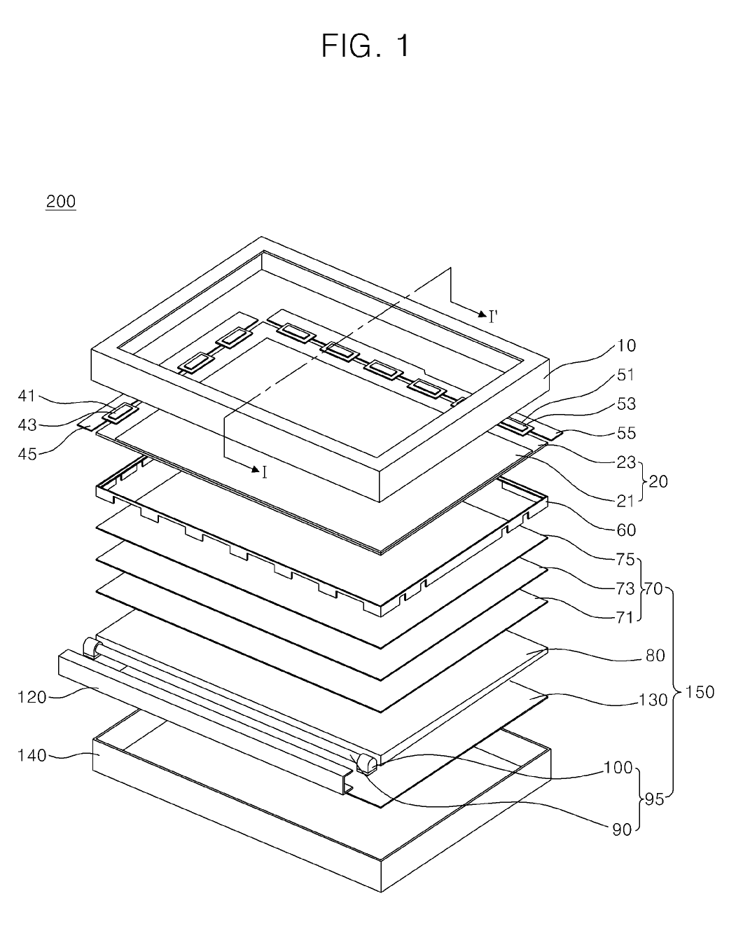

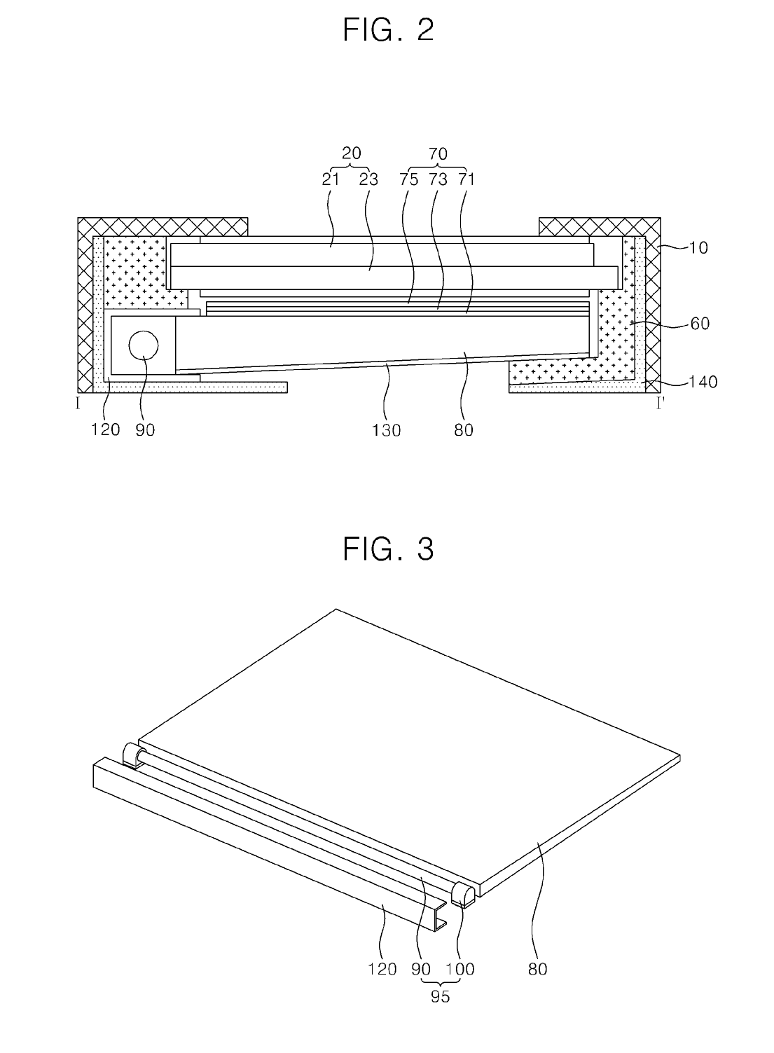

FIG. 1 is an exploded perspective view illustrating an exemplary embodiment of a liquid crystal display (“LCD”) device in accordance with the present invention, and FIG. 2 is a cross-sectional view taken along line I-I′ of FIG. 1.

Referring to FIGS. 1 and 2, the LCD device 200 includes a top chassis 10, an LCD panel 20, a driving circuit, a mold frame 60, a backlight assembly 150, and a bottom chassis 140.

The top chassis 10 is placed on an upper portion of the LCD panel 20 to protect the LCD panel 20 and the backlight assembly 150 from an external impact. The top chassis 10 has an opening portion formed in a middle section thereof to expose a display area of the LCD panel 20.

The LCD panel 20 includes a color filter substrate 21, a thin film transistor (“TFT”) substrate 23 formed at a position corresponding to the color filter substrate 21, and a liquid crystal layer (not shown) disposed between the color filter substrate 21 and the TFT substrate 23 and controlling an amount of light transmittance passing through the color filter substrate 21.

The color filter substrate 21 includes a black matrix formed in a matrix shape on an upper substrate, such as a glass substrate, to block light, red, green and blue color filters formed at pixel areas defined by the black matrix to display colors, a common electrode applying a common voltage to the liquid crystal layer, and an upper alignment layer formed on the common electrode for alignment of liquid crystal molecules in the liquid crystal layer.

The TFT substrate 23 includes a data line and a gate line formed to cross each other on a lower substrate such as glass with a gate insulating layer disposed therebetween, a TFT connected to the data line and the gate line, a pixel electrode applying a pixel voltage to the liquid crystal layer, and a lower alignment layer formed on the pixel electrode for alignment of the liquid crystal molecules in the liquid crystal layer. The TFT includes a gate electrode connected to the gate line, a drain electrode connected to the pixel electrode, and a source electrode connected to the data line and overlapping a portion of the gate electrode.

The driving circuit includes a gate driver integrated circuit (“IC”) 43 for driving the gate lines of the LCD panel 20, and a data driver IC 53 for driving the data lines of the LCD panel 20. Moreover, the driving circuit includes a timing controller, a power supply unit, and various circuit elements, and generates various signals required for displaying an image on the LCD panel 20. The timing controller, the power supply unit, and the various circuit elements are mounted on a gate printed circuit board (“PCB”) 45 and a data PCB 55.

Various signal circuits on the gate PCB 45 and the data PCB 55 are electrically connected to the gate lines and the data lines of the TFT substrate 23 through gate tape carrier packages (“TCPs”) 41 and data TCPs 51.

The mold frame 60 is formed of a molding material. A lower surface of the mold frame 60 supports a reflection sheet 130, a light guide plate 80, a light source unit 95, and an optical sheet 70. An upper surface of the mold frame 60 is formed to be opened so as to receive the LCD panel 20. The upper, lower, left and right sides of the mold frame 60 may be formed to have a height equal to or lower than that of the stacked reflection sheet 130, light guide plate 80 and optical sheet 70.

The backlight assembly 150 includes the light guide plate 80, the optical sheet 70, the light source unit 95, and the reflection sheet 130.

The light guide plate 80 converts a line light source emitted from the light source unit 95 into a surface light source and transmits the surface light source to the LCD panel 20. The light guide plate 80 for uniformly transmitting the light emitted from the light source unit 95 to the LCD panel 20 may be formed of a transparent acrylic material having a thickness of a few millimeters and may have a plurality of dots or V-shaped holes (not shown) formed on a lower surface thereof to uniformly reflect the light. The light guide plate 80 is formed to have a size corresponding to that of the LCD panel 20.

The optical sheet 70 is provided on an upper portion of the light guide plate 80 and changes the direction of light emitted from the light guide plate 80 toward the LCD panel 20. In an exemplary embodiment, the optical sheet 70 includes a diffusion sheet 71 diffusing the light emitted from the light guide plate 80, and a prism sheet 73 changing the light incident from the diffusion sheet 71 to be emitted vertically. Moreover, the optical sheet 70 includes a protection sheet 75 formed on the diffusion sheet 71 or the prism sheet 73 to protect the optical sheets 70 sensitive to dust or scratches and to prevent the optical sheets 70 from being moved during the transportation of the backlight assembly 150. The optical sheet 70 allows the light emitted from the light guide plate 80 to be vertically incident to the LCD panel 20, thus improving the light efficiency. While an exemplary embodiment of the optical sheet 70 has been described, alternative arrangements and numbers of optical sheets 70 would also be within the scope of these embodiments.

The light source unit 95 includes a light guide pipe 90 and a light source portion 100. The light source unit 95 is provided on a lateral surface of the light guide plate 80 formed parallel to the LCD panel 20. Moreover, an edge-lighting method is used in which the light emitted from the light source unit 95 is incident to the LCD panel 20 by the light guide plate 80.

As illustrated, the light guide pipe 90 may be formed to have a cylindrical shape. However, the present invention is not limited thereto and the light guide pipe 90 may alternatively include any column shaped structure such as, but not limited to, a square column, a cylindrical column, or other cross-sectional shape. A light guide pipe cover 120 is formed to cover the light source unit 95. The light guide pipe cover 120 is provided on the side of the light guide plate 80 so as to surround the outside of the light guide pipe 90 except for a portion directed to the light guide plate 80. The light guide pipe cover 120 is arranged spaced apart from the light guide pipe 90 at regular intervals, and a reflection layer is formed therein. The reflection layer may be formed by coating a reflecting material on the inside of the light guide pipe cover 120 or by attaching a reflective sheet thereon. Moreover, in another exemplary embodiment, one side of the reflection sheet 130 may be folded in the form of the light guide pipe cover 120 and used as the reflection layer within the light guide pipe cover 120.

The reflection sheet 130 reflects light incident to itself from the rear surface of the light guide plate 80 back towards the light guide plate 80 using a plate having a high light reflectivity, thus reducing the light loss of the light guide plate 80. A base material of the reflection sheet 130 is coated with a reflecting member having a high reflectivity. As the base material, brass, aluminum (Al), polyethyleneterephthalate (“PET”), or steel-use stainless (“SUS”) may be used. Moreover, as the reflecting member, silver (Ag), or titanium (Ti) may be used.

The bottom chassis 140 receives the backlight assembly 150 and surrounds the edge portion of the backlight assembly 150. The bottom chassis 140 further receives the mold frame 60 provided on the entire surface of the inside of the bottom chassis 140 and the LCD panel 20 placed on an upper portion of the mold frame 60.

Next, an exemplary embodiment of the light source unit 95 in accordance with the present invention will be described in more detail with reference to FIGS. 3 to 6.

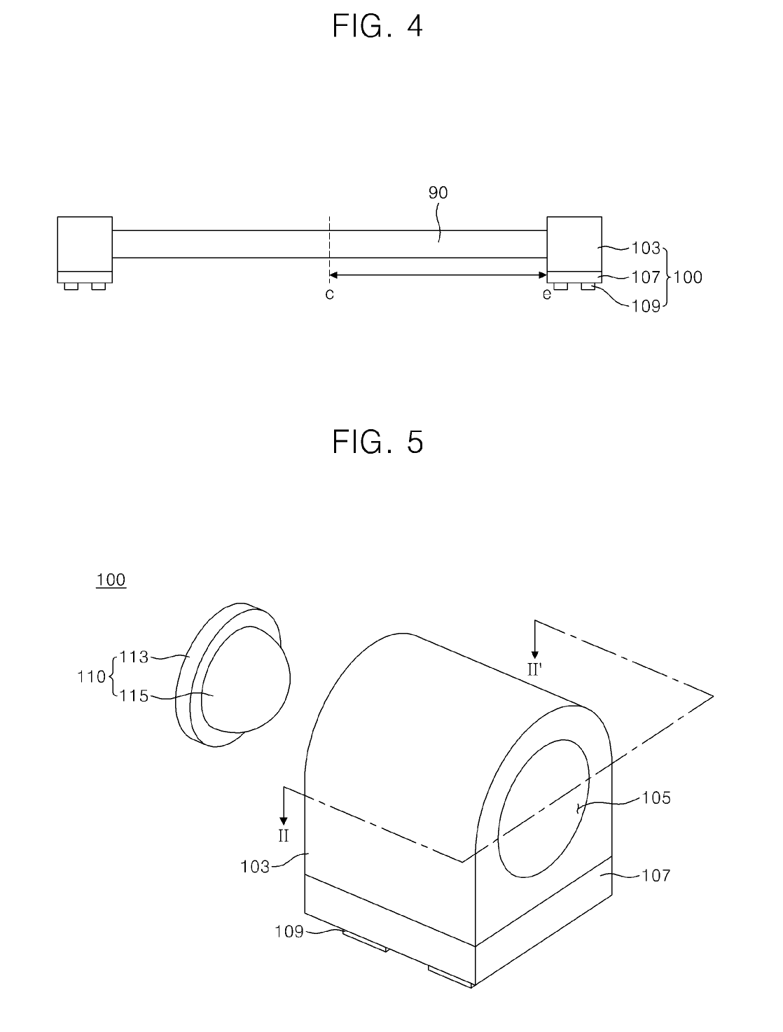

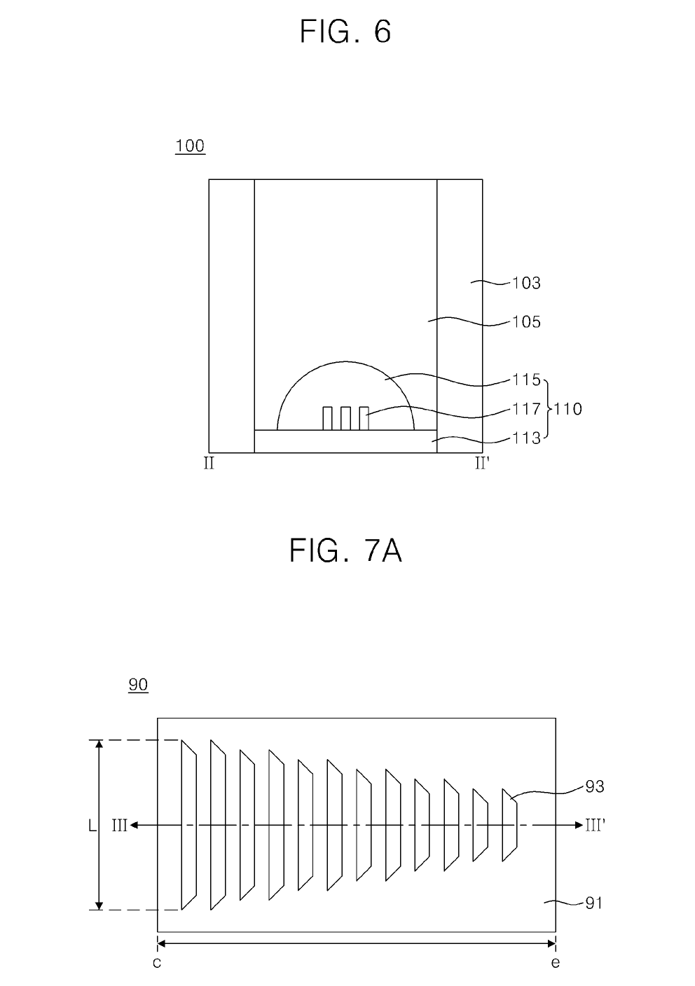

FIG. 3 is a perspective view illustrating an exemplary embodiment of the light source unit and the light guide plate of FIG. 1, FIG. 4 is a front view illustrating an exemplary embodiment of the light source unit of FIG. 3, FIG. 5 is an exploded perspective view of the exemplary light source portion, and FIG. 6 is a cross-sectional view taken along line II-II′ of FIG. 5.

Referring to FIGS. 3 and 4, the light source unit 95 includes the light source portion 100 generating light and the light guide pipe 90 emitting the light radiated from the light source portion 100.

The light source portion 100 includes a housing 103, a light emitting diode (“LED”) package (shown in FIG. 5), a power supply substrate 107, and an electrode 109. The light source portion 100 is arranged on both ends, that is, at first and second ends, of the light guide pipe 90 to transmit light to the light guide pipe 90.

As shown in FIG. 5, the housing 103 includes a hole 105 in which an LED package 110 and the light guide pipe 90 are inserted and connected. Moreover, as shown in FIG. 6, one end of the hole 105 of the housing 103 is connected to the LED package 110 and the other end of the hole 105 of the housing 103 is sized to receive the light guide pipe 90. In an exemplary embodiment, a first end of the light guide pipe 90 is adjacent to a first LED package 110 in a first housing 103, and a second end of the light guide pipe 90 is adjacent to a second LED package 110 in a second housing 103. The housing 103 is formed of a plastic material having a high heat resistance since the LED package 110 generates light. For example, the housing 103 may be formed of phenolic resin having a high heat resistance.

The LED package 110 includes a substrate 113, an LED 117, and a lens portion 115. As shown in FIG. 6, the LED package 110 is mounted on one end of the housing 103.

The LED 117 generates light and transmits the light to an end of the light guide pipe 90 through the lens portion 115. The LED 117 is mounted on the substrate 113. The lens portion 115 covers the LED 117 to protect the LED 117 and is bonded on the substrate 113. Moreover, as shown in FIGS. 5 and 6, the lens portion 115 may be a convex lens collecting the light emitted from the LED 117. Alternatively, the lens portion 115 may be a concave lens diffusing the light emitted from the LED 117. The lens portion 115 may include a plastic cap of a transparent material or silicon to surround the LED 117.

The power supply substrate 107 is formed on a lower portion of the housing 103 and supplies power to the LED 117. The electrode 109 is mounted on the power supply substrate 107. The substrate 113 on which the LED 117 is mounted is connected to the electrode 109 through a lead wire (not shown) to supply power to the LED 117. The power supply substrate 107 may be disposed between the electrode 109 and the substrate 113.

As shown in FIG. 3, the light guide pipe 90 is arranged on a lateral surface of the light guide plate 80. The light guide pipe 90 converts a point light source emitted from the light source portion 100 into a line light source and transmits the converted line light source to the light guide plate 80. As shown in FIG. 4, the light source portion 100 mounted on both ends of the light guide pipe 90 supplies light to the light guide pipe 90. The light guide pipe 90 is formed of a transparent material, such as a transparent polymer material, and may be formed in a cylindrical shape. For example, the light guide pipe 90 may include at least one of polymethylmethacrylate (“PMMA”), polycarbonate (“PC”), and polyethyleneterephthalate (“PET”).

The light guide pipe 90 includes an emitting portion 91 through which the light radiated from the light source portion 100 is emitted. The emitting portion 91 includes a plurality of emitting patterns 93 formed in an area facing the light guide plate 80.

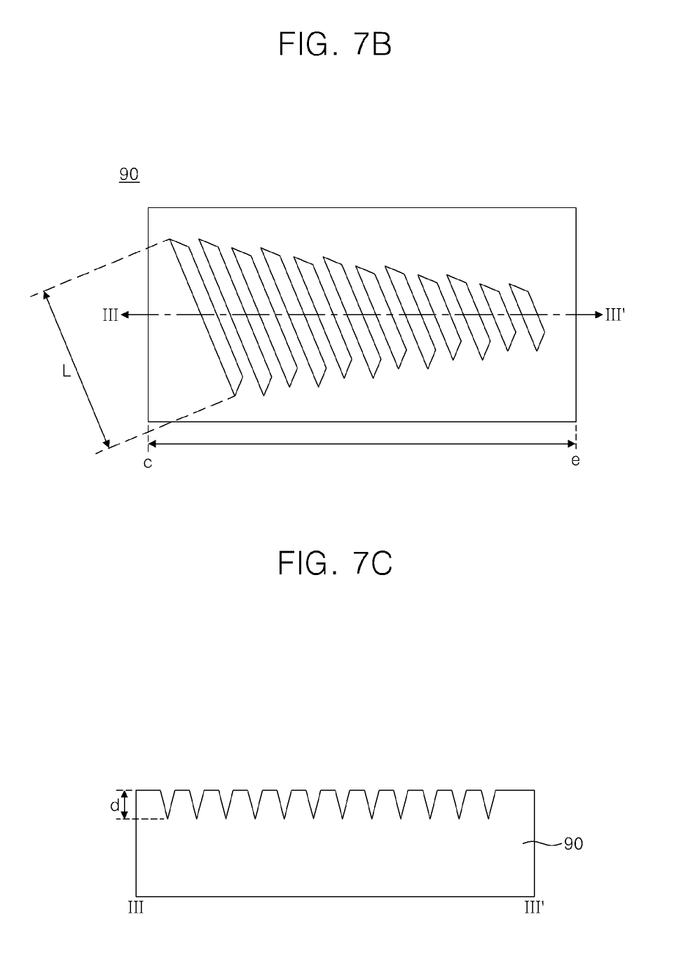

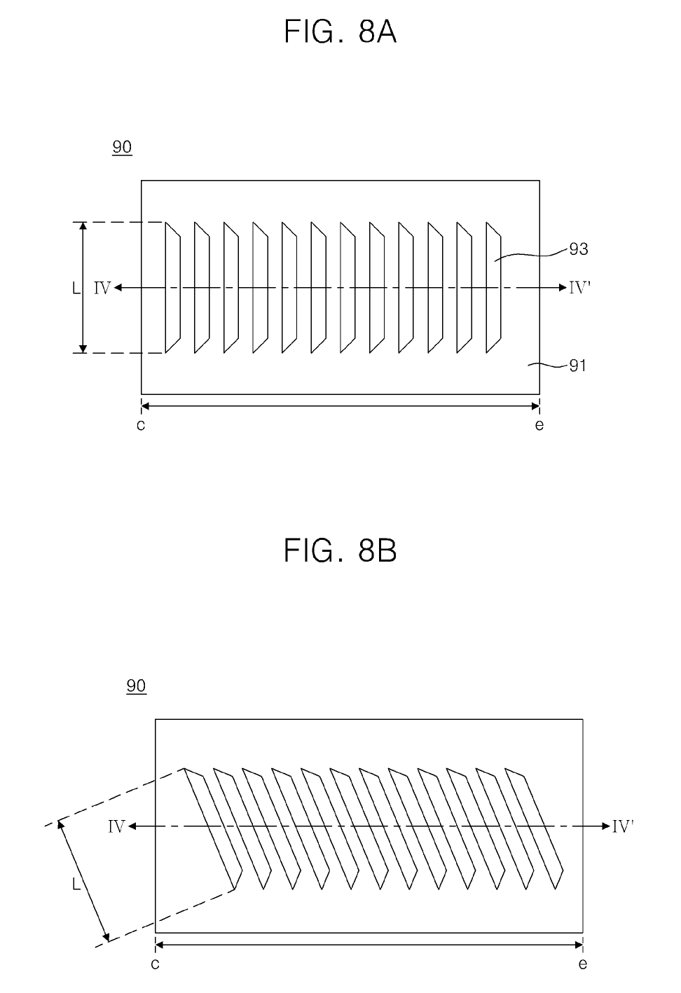

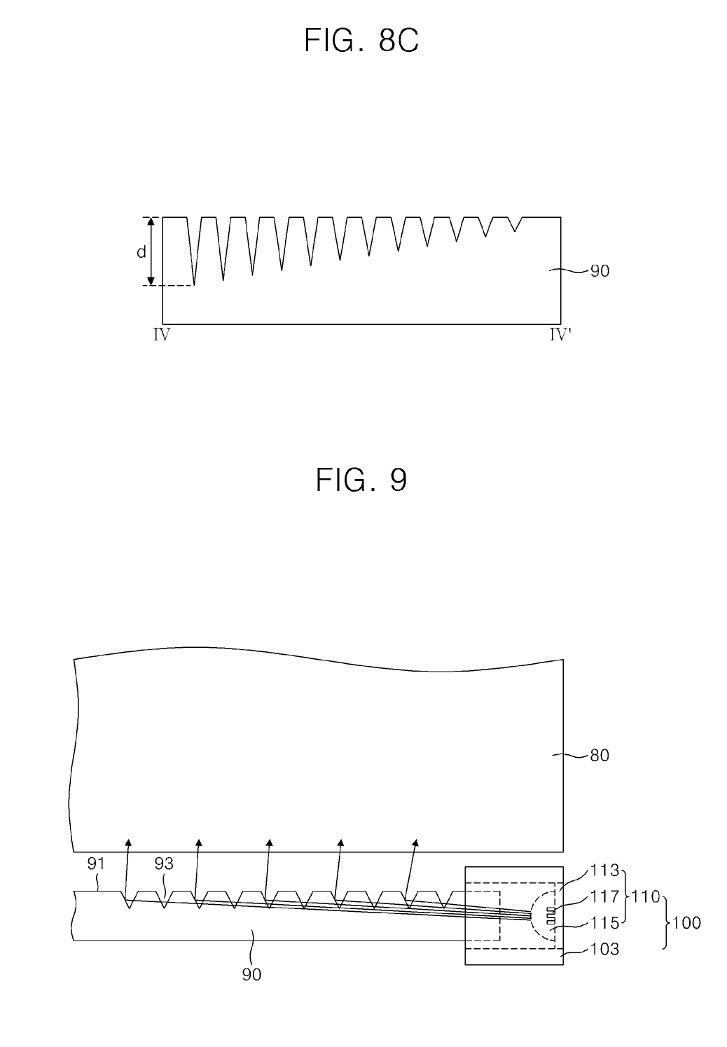

Various embodiments of the light guide pipe 90 in accordance with the present invention will be described with reference to FIGS. 7A to 8C.

FIG. 7A is an enlarged cross-sectional view illustrating a first exemplary embodiment taken along c-e of FIG. 4 in accordance with the present invention, FIG. 7B is an enlarged cross-sectional view illustrating a second exemplary embodiment taken along c-e of FIG. 4 in accordance with the present invention, and FIG. 7C is a cross-sectional view taken along line III-III′ of FIGS. 7A and 7B.

Referring to FIG. 7A, the emitting portion 91 includes a plurality of emitting patterns 93. The emitting patterns 93 in accordance with the present embodiment may be formed with grooves that are parallel to an end e of the light guide pipe 90. The length L of the grooves may be successively increased as the grooves are positioned from the end e of the light guide pipe 90 to the center c thereof. In other words, a length L of a groove positioned adjacent to the end e of the light guide pipe 90 is shorter than a length L of a groove positioned adjacent to the center c of the light guide pipe 90. Likewise, a first groove that is closer to the end e than a second groove will have a shorter length L than the second groove. The longer the length L of the groove is, the greater the reflection amount caused by the groove becomes. Accordingly, since the light intensity from the light source portion 100 is decreased in the vicinity of the center c of the light guide pipe 90, the length L of the grooves is increased as it goes from the end e to the center c, thus making the reflection amounts of the end e and the center c equal to each other, or substantially equal to each other. As a result, the light guide pipe 90 can uniformly transmit the light emitted from the light source portion 100 to the light guide plate 80.

Moreover, as shown in FIG. 7B, the grooves may alternatively be inclined with respect to the end e of the light guide pipe 90 and the length L of the grooves may be increased as the grooves are positioned from the end e to the center c. Furthermore, as shown in FIG. 7C, each of the grooves may be formed in a V shape with the same depth d, for the grooves in the embodiments of either FIG. 7A or 7B. While only a first half of a light guide pipe 90 is shown in FIGS. 7A to 7C, it should be understood that a second half of the light guide pipe 90 is similarly formed with a length L of the grooves formed on the second half decreasing from the center c to the second end e.

FIG. 8A is an enlarged cross-sectional view illustrating a third exemplary embodiment taken along c-e of FIG. 4 in accordance with the present invention, FIG. 8B is an enlarged cross-sectional view illustrating a fourth exemplary embodiment taken along c-e of FIG. 4 in accordance with the present invention, and FIG. 8C is a cross-sectional view taken along line IV-IV′ of FIGS. 8A and 8B.

Referring to FIG. 8A, the emitting portion 91 includes a plurality of emitting patterns 93. The emitting patterns 93 in accordance with the present embodiment may be formed with grooves having the same length L, despite differing locations along the longitudinal axis of the light guide pipe 90. Moreover, the grooves may be formed parallel to the end e of the light guide pipe 90.

Alternatively, as shown in FIG. 8B, the lengths L of the grooves adjacent the center c, the end e, and therebetween, may be equal to each other, as in FIG. 8A, but the grooves may be inclined with respect to the end e of the light guide pipe 90. Furthermore, as shown in FIG. 8C, the depth d of the grooves of either embodiment shown in FIG. 8A or 8B may be increased as the grooves are positioned from the end e of the light guide pipe 90 to the center c thereof. The greater the depth d of the groove is, the greater the reflection amount becomes. Since the light intensity from the light source portion 100 is decreased in the vicinity of the center c of the light guide pipe 90, the depth d of the grooves is increased as positioning of the grooves goes from the end e to the center c, thus making the reflection amounts of the end e and the center c equal to each other, or substantially equal to each other. As a result, the light source portion 100 can uniformly transmit light to the light guide plate 80.

FIG. 9 is a plan view illustrating a state in which light emitted from the exemplary light source portion is emitted through the exemplary emitting patterns of the exemplary light guide pipe.

Referring to FIG. 9, the light emitted from the LED 117 of the light source portion 100 is reflected by the emitting patterns 93 of the light guide pipe 90, which face the light guide plate 80, and is transmitted to the light guide plate 80. The light emitted from the LED 117 formed on the substrate 113 of the LED package 110 is reflected by each one side of the emitting patterns 93 formed on the emitting portion 91 of the light guide pipe 90 and thus emitted to the light guide plate 80. In other words, for each groove formed in the light guide pipe 90, light is reflected from a side of the groove that faces the end e to which the groove is closest, and reflects the light towards the light guide plate 80. The light guide plate 80 transmits the received light to the LCD panel 20 through the optical sheet 70. At this time, the light guide pipe 90 converts the point light source radiated from the LED 117 into the line light source and emits the line light source to the light guide plate 80.

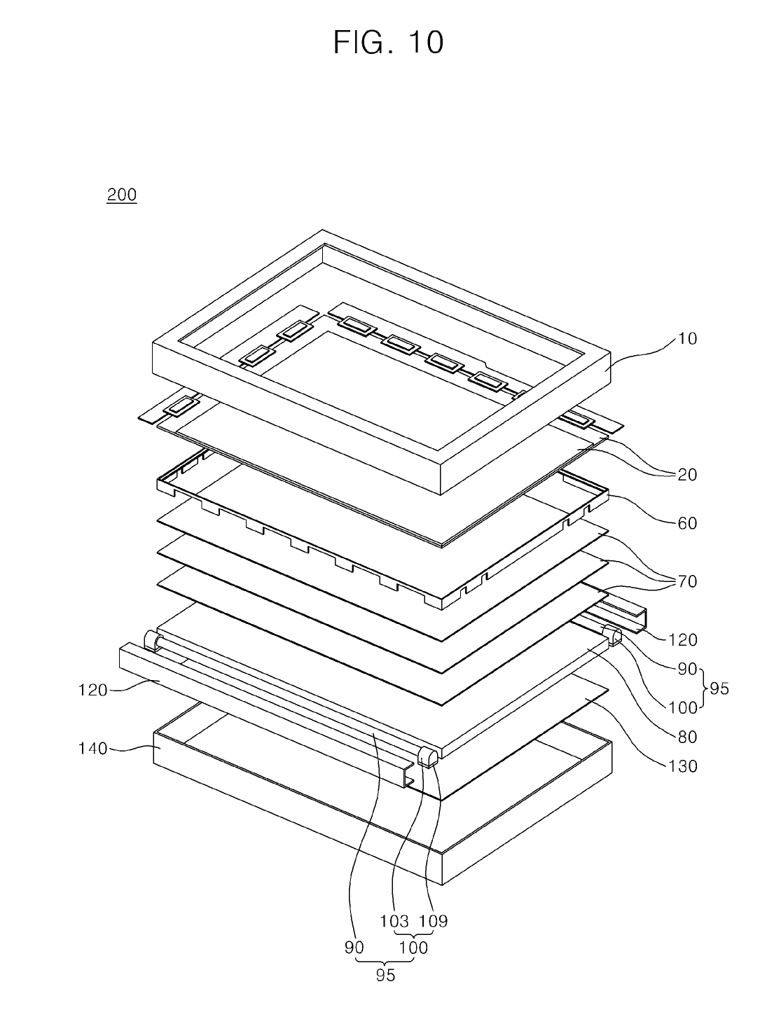

FIG. 10 is an exploded perspective view illustrating another exemplary embodiment of an LCD device in accordance with the present invention.

The LCD device 200 shown in FIG. 10 includes the same elements, or substantially the same elements, as those shown in FIG. 1, except that the light source unit 95 is provided on opposing sides of the light guide plate 80, and thus a detailed description of the same or substantially same elements will be omitted.

Referring to FIG. 10, the light source unit 95 includes the light guide pipe 90 having a columnar shape, such as a cylindrical shape, and converting light incident to the inside thereof into a line light source, and the light source portion 100 provided on first and second ends of the light guide pipe 90. The light source unit 95 is provided on first and second opposing sides of the light guide plate 80 to supply light to the LCD panel 20. The emitting patterns 93 formed on the emitting portion 91 of each light guide pipe 90 are arranged in the direction of the light guide plate 80. The light emitted from each LED package 110 is transmitted to the light guide plate 80 through the emitting patterns 93 and the light guide plate 80 transmits the received light to the LCD panel 20 through the optical sheet 70. While the light guide plate 80 of FIG. 1 may be provided with a thickness decreasing from a first end adjacent to the light source unit 95 to an opposing second end, the light guide plate 80 of FIG. 10 may instead have a substantially uniform thickness, or a substantially symmetric thickness, from the first end of the light guide plate 80 adjacent a first light guide pipe 90 to a second end of the light guide plate 80 adjacent a second light guide pipe 90.

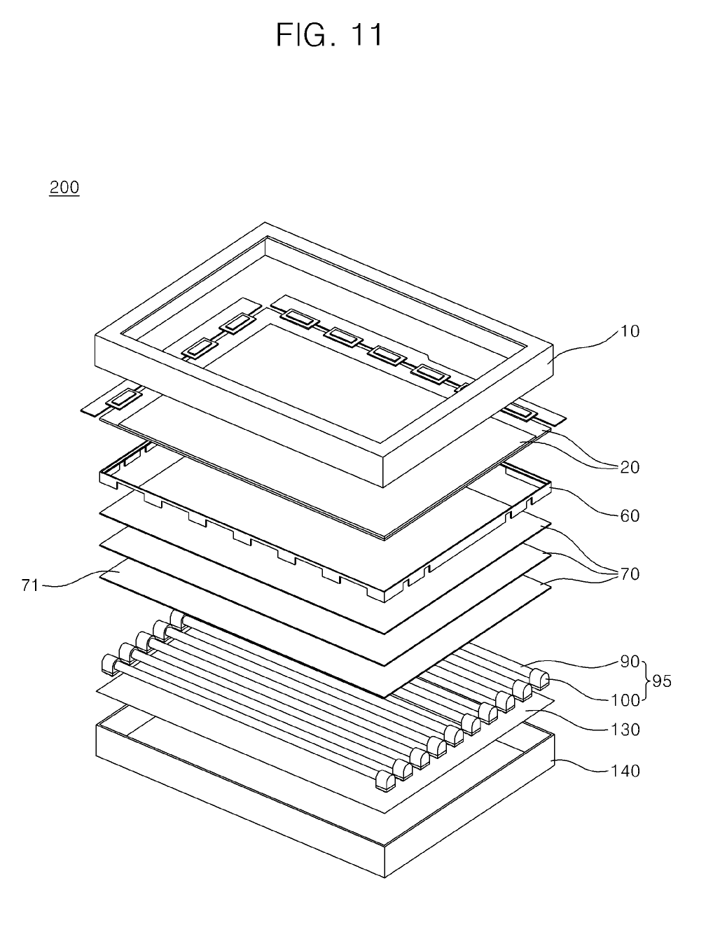

FIG. 11 is an exploded perspective view illustrating a further exemplary embodiment of an LCD device in accordance with the present invention.

The LCD device 200 shown in FIG. 11 includes the same elements, or substantially the same elements, as those shown in FIG. 1, except that the light source unit 95 is provided on a lower portion of the optical sheet 70, and the light guide plate 80 is not provided, and thus a detailed description of the same or substantially same elements will be omitted.

Referring to FIG. 11, the light source unit 95 includes the light guide pipe 90 and the light source portion 100 supplying light to the light guide pipe 90. Moreover, a plurality of light source units 95 is formed on a lower portion of the optical sheet 70 parallel to the LCD panel 20 to directly transmit light to the LCD panel 20 through the optical sheet 70. The plurality of light source units 95 is formed on a lower portion of the diffusion sheet 71 of the optical sheet 70 to transmit light to the LCD panel 20, and the plurality of light source units 95 are disposed between the diffusion sheet 71 and the reflection sheet 130. The emitting patterns 93 formed on the light guide pipe 90 of each light source unit 95 are arranged in the direction of the diffusion sheet 71 and thereby the light emitted from the light source portion 100 is transmitted to the LCD panel 20.

As described above, the present invention provides a light source unit, which includes a light source and a light guide pipe converting light emitted from the light source into a line light source, a backlight assembly including the light source unit, and an LCD device including the backlight assembly.

Since the light source unit includes the light guide pipe instead of a plurality of LEDs, it is possible to manufacture the LCD device at low cost using a small number of LEDs. Moreover, it is possible to provide a uniform brightness by means of emitting patterns formed on the light guide pipe and solve the non-uniformity of brightness caused when using the LEDs. Furthermore, since the number of LEDs is reduced, it is possible to drive the LCD device at low power consumption.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A light source unit comprising:
a light source; and
a light guide pipe formed in a columnar shape and including a plurality of grooves, to which light emitted from the light source is incident, wherein dimensions of the grooves further from the light source are different from dimensions of the grooves closer to the light source, respectively.

2. The light source unit of claim 1, wherein a length of a groove positioned further from the light source is longer than a length of a groove positioned closer to the light source.

3. The light source unit of claim 2, wherein lengths of the grooves increases, respectively, towards a center portion of the light guide pipe.

4. The light source unit of claim 1, wherein a depth of a groove positioned further from the light source is deeper than a depth of a groove positioned closer to the light source.

5. The light source unit of claim 4, wherein depths of the grooves increases, respectively, towards a center portion of the light guide pipe.

6. The light source unit of claim 1, wherein the light guide pipe has a cylindrical shape.

7. The light source unit of claim 1, wherein the light source includes a first light source positioned at a first end of the light guide pipe, and a second light source positioned at a second end of the light guide pipe.

8. The light source unit of claim 1, wherein the light source includes a point light source emitting the light, and the grooves reflect the light from the point light source to form a line light source of substantially uniform brightness.

9. A backlight assembly comprising:
a light source unit emitting light; and
a light guide plate guiding the light emitted from the light source unit,
wherein the light source unit comprises: a light guide pipe formed in a columnar shape and including a plurality of emitting patterns formed on a surface facing the light guide plate; and a light source portion connected to at least one end of the light guide pipe and emitting light to an inside of the light guide pipe.

10. The backlight assembly of claim 9, wherein the emitting patterns are grooves formed to be parallel to both ends of the light guide pipe.

11. The backlight assembly of claim 9, wherein the emitting patterns are grooves formed to be angled with respect to both ends of the light guide pipe.

12. The backlight assembly of claim 9, wherein the emitting patterns are grooves, and the grooves have a substantially V shaped section.

13. The backlight assembly of claim 9, wherein the emitting patterns are grooves formed on the light guide pipe, and a depth of a groove positioned closer to an end of the light guide pipe is less than a depth of a groove positioned adjacent a center portion of the light guide pipe.

14. The backlight assembly of claim 9, wherein the emitting patterns are grooves formed on the light guide pipe, and a length of a groove positioned closer to an end of the light guide pipe is less than a length of a groove positioned adjacent a center portion of the light guide pipe.

15. The backlight assembly of claim 9, wherein the light source portion comprises:
a housing including an insertion hole of which a first end of the insertion hole receives the light guide pipe;
a light emitting diode package connected within a second end of the insertion hole and including a light emitting diode emitting light; and
a power supply substrate formed on a lower portion of the housing and supplying power to the light emitting diode.

16. The backlight assembly of claim 9, wherein the light source portion includes a point light source emitting the light, and the emitting patterns reflect the light from the point light source to form a line light source of substantially uniform brightness.

17. A liquid crystal display device comprising:
a liquid crystal display panel displaying an image;
a light source unit formed on a lower portion of the liquid crystal display panel and emitting light; and
an optical sheet formed on the lower portion of the liquid crystal display panel,
wherein the light source unit comprises: a light source emitting light; and a light guide pipe formed in a columnar shape and including a plurality of grooves, to which the light emitted from the light source is incident, wherein dimensions of the grooves further from the light source are different from dimensions of the grooves closer to the light source, respectively.

18. The liquid crystal display device of claim 17, wherein a length of a groove positioned further from the light source is longer than a length of a groove positioned closer to the light source.

19. The liquid crystal display device of claim 17, wherein a depth of a groove positioned further from the light source is deeper than a depth of a groove positioned closer to the light source.

20. A liquid crystal display device comprising:
a liquid crystal display panel displaying an image;
a plurality of light source units formed on a lower portion of the liquid crystal display panel and emitting light and arranged parallel to each other; and
an optical sheet formed on the lower portion of the liquid crystal display panel,
wherein each of the light source units comprises: a light guide pipe formed in a columnar shape; and a light source portion connected to at least one end of the light guide pipe and emitting light to an inside of the light guide pipe, and
the light guide pipe includes a plurality of emitting patterns formed on a surface facing the optical sheet.

21. The liquid crystal display device of claim 20, wherein a length of a groove positioned further from the light source is longer than a length of a groove positioned closer to the light source.

22. The liquid crystal display device of claim 20, wherein a depth of a groove positioned further from the light source is deeper than a depth of a groove positioned closer to the light source.
